(19) United States
(12) Patent Application Publication
(10) Pub. No.: US 2018/0207808 A1
(43) Pub. Date: Jul. 26, 2018

(54) HOLDING DEVICE CAPABLE OF SUCKING AN OBJECT, HOLDING METHOD CAPABLE OF SUCKING AN OBJECT, AND UNLOADING APPARATUS USING A HOLDING DEVICE

(71) Applicant: Kabushiki Kaisha Toshiba, Minato-ku (JP)

(72) Inventor: Junya TANAKA, Ota (JP)

(73) Assignee: Kabushiki Kaisha Toshiba, Minato-ku (JP)

(21) Appl. No.: 15/683,042

(22) Filed: Aug. 22, 2017

(30) Foreign Application Priority Data
Jan. 24, 2017 (JP) 2017-010503

(51) Int. Cl. B25J 15/06

(52) U.S. Cl. CPC B25J 15/0616

(57) ABSTRACT

A holding device includes a first suction pad capable of sucking an object; a second suction pad capable of sucking the object, said second suction pad surrounding the first suction pad on a plane; and a moving mechanism relatively moving the first suction pad toward the second suction pad in a first direction from the first suction pad toward the object.

### CROSS-REFERENCE TO RELATED APPLICATIONS

This application is based upon and claims the benefit of priority from the prior Japanese Patent Application No. 2017-010503, filed on Jan. 24, 2017, the entire contents of which are incorporated herein by reference

### 1. FIELD

Embodiments of the present invention relate to a holding device capable of sucking an object, a holding method capable of sucking an object, and an unloading apparatus using a holding device.

### 2. DESCRIPTION OF THE RELATED ART

A vacuum suction system using a vacuum suction pad is mainly and widely employed as a holding device that moves a package while holding the package. The reason for this is that a package can be held even though the package is larger than a holding device in a case in which air is discharged from a contact internal space between the package and a vacuum suction pad to lower the pressure of the internal space and the package is held by differential pressure between the atmospheric pressure and the pressure of the internal space. In order to make the holding device reliably suck and hold a package, it is preferable that a suction pad suitable for the package is used according to the shape or size of the package. In a case in which there are plural types of packages to be held, it is necessary to exchange a suction pad in each case or to exchange a holding device provided with a suction pad to selectively use a different suction pad for each package.

For this purpose, a suction pad of which the size of the suction surface for sucking a package can be switched is proposed. For example, a device that includes a negative pressure valve provided in a suction pad and selectively switches the suction area of the suction pad to a small opening portion or a large opening portion according to a suction state is proposed.

### SUMMARY

The invention has been made in view of the above circumstances, and provides a holding device capable of sucking an object.

A holding device according to an embodiment includes a first suction pad capable of sucking an object; a second suction pad capable of sucking the object, said second suction pad surrounding the first suction pad on a plane; and a moving mechanism relatively moving the first suction pad toward the second suction pad in a first direction from the first suction pad toward the object.

A holding method according to another embodiment includes sucking an object with an outer suction pad; holding the object when the pressure of the outer suction pad is over a predetermined first pressure; moving relatively the outer suction pad toward an object when the pressure of the outer suction pad is under the predetermined first pressure; sucking an object with an inner suction pad and, holding the object with the inner suction pad.

An unloading apparatus according to still another embodiment includes a holding device including a first suction pad capable of sucking a suction surface of an object, a second suction pad capable of sucking the suction surface of the object, the second suction pad surrounding the first suction pad on a plane and a moving mechanism relatively moving the first suction pad and the second suction pad in a first direction from the first suction pad toward the object; and a manipulator having the holding device; and a robot control device controlling the manipulator.

Further, A holding device according to another embodiment includes a first suction pad sucking a suction surface of an object; a second suction pad sucking the suction surface of the object, the second suction pad surrounding the first suction pad on a plane substantially orthogonal to a first direction from the first suction pad toward the object; an elastic sheet covering a side of the first suction pad and a side of the second suction pad; a case forming an predetermined space between the elastic sheet; and a moving mechanism relatively moving the first suction pad and the second suction pad in the first direction by discharging or supplying air into the sp ace.

### BRIEF DESCRIPTION OF THE DRAWINGS

FIG. 1 is a diagram illustrating a holding device according to a first embodiment;

FIG. 2A is a diagram illustrating the appearance of a suction unit of the first embodiment, and FIG. 2B is a cross-sectional view of the suction unit;

FIG. 3 is a flow chart illustrating the operation of a holding method according to the first embodiment;

FIGS. 4A and 4B are diagrams illustrating the operation of the holding device according to the first embodiment;

FIG. 5 is a diagram illustrating a holding device according to a second embodiment;

FIG. 6 is a diagram illustrating a holding device according to a fourth embodiment;

FIG. 7 is a diagram illustrating a holding device according to a third embodiment;

FIG. 8A is a cross-sectional view of a flat tube having contracted and FIG. 8B is a cross-sectional view of the flat tube having expanded;

FIG. 9 is a flow chart illustrating the operation of a holding method according to the third embodiment; and

FIG. 10 is a diagram illustrating an example of an unloading apparatus according to a fifth embodiment.

### DETAILED DESCRIPTION OF THE PREFERRED EMBODIMENTS

Embodiments of the invention will be described below with reference to the drawings. Components denoted by the same reference numerals indicate components corresponding to each other. Meanwhile, the drawings are schematic or conceptual, and the relation between a thickness and a width in each portion, and a ratio of a size between portions, and so on are necessarily the same as the actual ones. Further, when the same portion is shown, the respective dimensions and ratios may be shown in different sizes and values depending on the drawings.

### First Embodiment

FIG. 1 illustrates a holding device according to the present embodiment.

The holding device according to the present embodiment includes a suction unit 18 that includes a space portion in which negative pressure or positive pressure can be generated to suck or detach an object 20 (for example, a package), and a fluid control device 8 (also referred to as a selection unit) that generates negative pressure or positive pressure by discharging fluid from the space portion of the suction unit 18 or supplying fluid to the space portion. The fluid control device 8 will be described below.

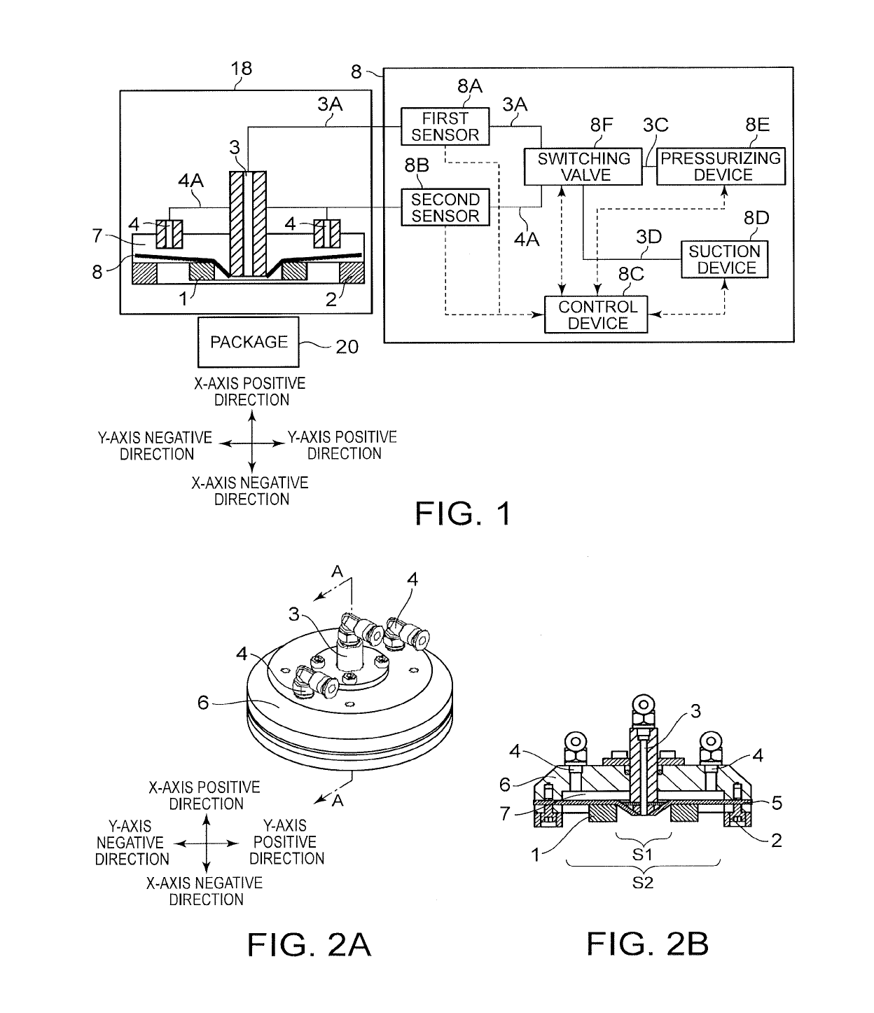

FIG. 2A is a diagram illustrating the appearance of the suction unit 18 of the present embodiment, and FIG. 2B is a cross-sectional view of the suction unit 18 taken along line A-A.

The suction unit 18 includes a first suction pad 1 that has a cylindrical shape in a first direction and has a suction area S1 at one end thereof (the package 20 side) in a plane orthogonal to the first direction, a second suction pad 2 that is coaxial with the first suction pad 1 and has a suction area S2 larger than the area S1 at one end thereof (the package 20 side), and a flow passage 3 that supplies or discharges fluid to or from a suction space formed by a suction surface of the first or second suction pad 1 or 2 sucking the package. For example, liquid, gas, and the like are used as the fluid.

The first direction means a direction (X-axis positive direction) from one end (the suction surface sucking the package 20, for example, a lower side) of the first suction pad 1 toward the other end (for example, an upper side) of the first suction pad 1. Further, the first direction may be a direction (X-axis negative direction) from the other end (for example, the upper side) of the first suction pad 1 toward one end (the suction surface sucking the package 20, for example, the lower side) of the first suction pad 1. The first direction is also defined in the case of the second suction pad 2 likewise.

The suction area is an area inside the suction surface in this specification.

The suction unit 18 further includes an elastic sheet 5 that covers the other end of the first suction pad 1 and the other end of the second suction pad 2 in the first direction and is connected to an edge of the flow passage 3 not to hinder the discharge or supply of fluid, and a case part 6 for forming an outer shell. A closed space portion 7, which can expand and contract, is formed between the elastic sheet 5, the flow passage 3, and the case part 6. Flow passages 4 and 4, which are independent of the flow passage 3 and discharge or supply fluid, are connected to the closed space portion 7. Further, the positions of the flow passages 3, 4, and 4 are fixed by the case part 6 for forming an outer shell.

The first and second suction pads 1 and 2 are formed along the first direction in a substantially cylindrical shape. Further, one end of each of the suction pads 1 and 2 in the first direction can come into contact with the surface to be sucked of the package 20 and the other end thereof is connected to the flow passage 3. Since the first suction pad 1 is supported by the elastic sheet 5 in this embodiment, the position of one end of the first suction pad 1 is changed (moved) in the first direction when the elastic sheet 5 is deformed. On the other hand, since the second suction pad 2 is supported by the elastic sheet 5 and the case part 6, the position of one end of the second suction pad 2 is not changed even though the elastic sheet 5 is deformed.

The second suction pad 2 has a diameter larger than the diameter of the first suction pad 1, and is formed in a substantially circular shape. For this reason, the suction area S2 is larger than the suction area S1.

The flow passage 3, which discharges or supplies air from or to a contact internal space formed by the first suction pad 1, the elastic sheet 5, and the surface to be sucked of the package 20, is formed of a through hole and is connected to the fluid control device 8. Since the contact internal space, which is formed by the first or second suction pad 1 or 2, the elastic sheet 5, and the surface to be sucked of the package, can be in a negative pressure state or a positive pressure state by the control of the discharge or supply of air from or to the flow passage 3, the package 20 can be sucked and held or detached.

On the other hand, each of the flow passages 4 and 4, which discharge or supply air from or to the closed space portion 7, is formed of a through hole and is connected to the fluid control device 8. It is possible to selectively determine one, which is used to suck and hold the package 20, of the first and second suction pads 1 and 2 by performing control for switching the pressure state of the closed space portion 7 to a negative pressure state and a positive pressure state, through the flow passages 4 and 4.

In this specification, the “package” is an object having a surface to be sucked. For example, the package may be a box-shaped object that is made of plastic or a corrugated cardboard.

The first and second suction pads 1 and 2 are inner and outer double suction pads when seen from the package 20 to be sucked. The inner and outer double suction pads means that the second suction pad 2 surrounds the first suction pad 1 on a plane including a Y axis substantially orthogonal to an X axis.

Here, in regard to “surround”, the second suction pad 2 may surround the first suction pad 1 so as to be in contact with the first suction pad 1 and may surround the first suction pad 1 so as to be spaced apart from the first suction pad 1.

The suction surface is the surface of any one of the first and second suction pads 1 and 2 sucking the package 20.

The fluid control device 8 controls the flow of fluid, for example, air that is to be supplied or discharged to or from the suction pad. The fluid control device 8 includes flow passages of two systems. In the first system, a tube 3A includes a first pressure sensor 8A that is provided on the middle of the path thereof and measures pressure in the tube 3A, and is connected to a switching valve 8F. A control device 8C collects the measured values of the first pressure sensor 8A. A tube 3C connects the switching valve 8F to a pressurizing device 8E that supplies air to generate positive pressure. Further, a tube 3D connects the switching valve 8F to a suction device 8D that discharges air to generate negative pressure.

Next, in the second system, a tube 4A includes a second pressure sensor 8B that is provided on the middle of the path thereof and measures the pressure of the flow passages 4 and 4, and is connected to the switching valve 8F. The control device 8C collects the measured values of the second pressure sensor 8B.

The control device 8C controls the operation of at least one of the switching valve 8F, the pressurizing device 8E, and the suction device 8D by using the measured values of the first pressure sensor 8A and the measured values of the second pressure sensor 8B. The switching valve 8F switches an internal flow passage thereof on the basis of a command signal sent from the control device 8C. The pressurizing device 8E or 8D adjusts the amount of air to be supplied or discharged on the basis of a command signal sent from the control device 8C.

For example, a vacuum pump is used as the suction device 8D. For example, a compressor is used as the pressurizing device 8E.

It is preferable that each of the tubes 3A and 4A is a flexible tube, and it is preferable that each of the tubes 3A and 4A does not expand and burst by being pressurized and does not collapse by being sucked.

Meanwhile, the sensor provided on the path of the tube is not limited to the pressure sensor, and a flow sensor may be provided on the path of the tube and both a pressure sensor and a flow sensor may be provided on the path of the tube. Further, since the flow sensor detects the amount of fluid to be supplied or discharged to or from each of the suction pad and the closed space in a case in which a flow sensor is disposed instead of the pressure sensor, for example, the control device 8C can use the measured values of the flow sensor to estimate supply or discharge completion time, and to determine whether or not the suction state of the package can be maintained by detecting the flow rate of fluid leaking between the suction pad and the package in a suction holding state. The suction state means a state in which the first or second suction pad 1 or 2 sucks the package 20.

A device that generates negative pressure by a combination of a pressurizing unit and a vacuum generator may be used as the suction device 8D other than a vacuum pump. Meanwhile, the switching valve 8F may be a type of valve that is operated by air pressure.

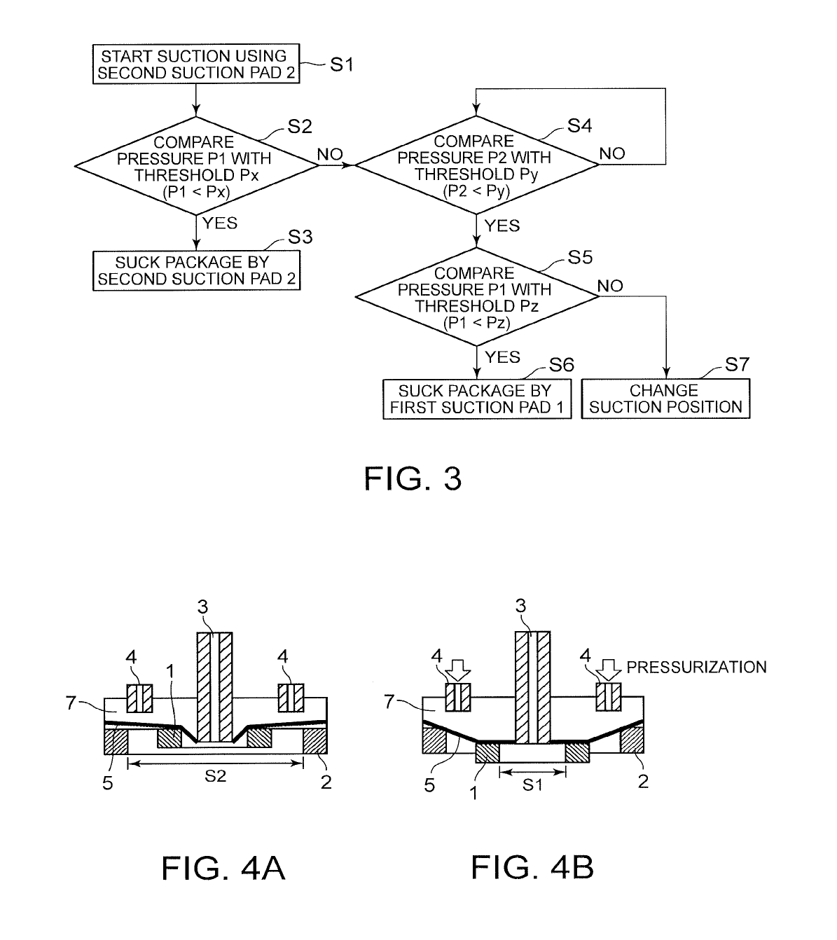

FIG. 3 is a flow chart illustrating a holding method according to the present embodiment. The operation will be described while assuming a case in which the suction unit 18 is disposed at the tip portion of a manipulator (not illustrated). Meanwhile, FIG. 3 illustrates an operation for selectively switching a suction area to the second suction pad 2 that is a large opening portion and the first suction pad 1 that is a small opening portion in the holding method.

First, the suction unit 18 is moved to the surface to be sucked of the package by the manipulator (not illustrated), and the second suction pad 2 is pressed against the surface to be sucked of the package. From this state, the control device 8C instructs the switching valve 8F to perform a switching operation so that the suction device 8D is connected to the tube 3A, and makes the suction device 81) start sucking air (Step S1).

When the suction device 81) starts sucking air, negative pressure is generated in the suction space, which is surrounded by the inner surface of the second suction pad 2 and the surface to be sucked of the package, through the flow passage 3. Accordingly, the second suction pad 2 and the package are in close contact with each other. At this time, the control device 8C measures pressure P1 in the flow passages 3 and 3A by the pressure sensor 8A and collects the measured values of the pressure sensor 8A. The control device 8C compares the pressure P1 with a threshold Px. The threshold Px is a value as a criterion that is used to determine whether or not negative pressure sufficient for the second suction pad 2 to hold the package is generated (Step S2).

If P1 is smaller than Px, the control device 8C determines that a sufficient suction force is generated and the package is sucked and held by the second suction pad 2 as it is (Yes in Step S2, Step S3).

On the other hand, since air flows into the suction space in a case in which, for example, a gap is formed between the second suction pad 2 and the surface to be sucked, sufficient negative pressure cannot be obtained. If P1 is not smaller than Px, the control device 8C determines that a sufficient suction force is not generated. A situation in which a small gap is formed between the suction pad 2 and the surface to be sucked of the package since, for example, corners or uneven portions of the package are sucked is thought. When an operation for sucking the package is performed in this state, there is a possibility that the package cannot be held by the second suction pad 2. For this reason, the package needs to be reliably held by the first suction pad 1 (No in Step S2).

First, the control device 8C instructs the switching valve 8F to perform a switching operation so that the pressurizing device 8E is connected to the tube 4A, and makes the inside of the closed space portion 7, which can expand and contract, of the suction unit 18 be pressurized through the flow passages 4 and 4. Since a part of the closed space portion 7 is formed of the elastic sheet 5, the closed space portion 7 can expand. For this reason, as the space portion 7 expands, the suction surface of the first suction pad 1, which is supported by the elastic sheet 5, protrudes so as to be closer to the surface to be sucked of the package than the suction surface of the second suction pad 2. At this time, the control device 8C measures pressure P2 in the flow passages 4 and 4 or 4A by the pressure sensor 8B and collects the measured values of the pressure sensor 8B. The control device 8C compares the pressure P2 with a threshold Py (Step S4). The threshold Py is a value as a criterion that is used to determine whether or not the suction surface of the first suction pad 1 sufficiently protrudes toward the surface to be sucked of the package. If P2 is larger than Py, the control device 8C determines that a protrusion distance is sufficient and processing proceeds to a suction operation that is the next step (Yes in Step S4). If P2 is smaller than Py, the inside of the closed space portion 7 continues to be pressurized (No in Step S4).

The control device 8C instructs the switching valve 8F to perform a switching operation from a state in which the first suction pad 1 is pressed against the surface to be sucked of the package so that the suction device 8D is connected to the tube 3A. Next, the control device 8C determines whether or not the package can be sucked by the first suction pad 1. The control device 8C measures the pressure P1 in the flow passage 3 by the pressure sensor 8A and collects the measured values of the pressure sensor 8A. The control device 8C compares the pressure P1 with a threshold Pz (Step S5). The threshold Pz is a value as a criterion that is used to determine whether or not negative pressure sufficient for the first suction pad 1 to hold the package is generated. If P1 is smaller than Pz, the control device 8C determines that a sufficient suction force is generated and the package is sucked and held by the first suction pad 1 as it is (Yes in Step S5, Step SG). On the other hand, since air flows into the suction space in a case in which, for example, a gap is formed between the first suction pad 1 and the surface to be sucked, sufficient negative pressure cannot be obtained. The control device 8 stops suction, and instructs the manipulator (not illustrated) to change the current suction position of the suction unit 18 (No in Step S5, Step S7). Accordingly, the suction position is changed and a suction operation is performed again. The package is sucked and held by the above-mentioned steps.

Meanwhile, a control unit, which gives a command for changing a driving state to the suction device 8D from the control device 8C when the suction pads 1 and 2 are switched, may be provided. The driving state means a state strengthen or weaken a suction force of the suction device 8D.

For example, the control unit may perform control for changing the operating frequency of a drive unit of the suction device 8D to adjust the amount of air to be discharged and increasing or reducing ultimate vacuum pressure.

Next, the operation of the holding device will be described with reference to FIG. 4A.

A suction-holding operation in a case in which the area of the surface to be sucked of the package is sufficiently larger than the suction area S2 of the holding device according to the present embodiment will be described.

In a case in which the area of the surface to be sucked of the package is larger than the suction area S2 of the second suction pad 2 (here, referred to as a large package), desired pressure is obtained when the fluid control device 8 is operated after the second suction pad 2 is in contact with the package. When negative pressure continues to be maintained by the fluid control device 8 in a case in which desired pressure is obtained, a large package can be sucked by the suction pad. When arbitrary time while the package is held by the suction pad has passed, the generation of negative pressure performed by the fluid control device 8 is stopped. If air flows into the suction space surrounded by the inner surface of the suction pad and the surface to be sucked of the package when the generation of negative pressure performed by the fluid control device 8 is stopped, a difference is not present between the pressure in the suction pad and the atmospheric pressure outside the suction pad. Accordingly, the large package, which has been sucked by the suction pad, is spaced apart from the suction pad by its own weight. When a large package is to be sucked, a positional relationship between the first and second suction pads 1 and 2 of the holding device according to the present embodiment is a positional relationship in which one end of the second suction pad 2 is positioned closer to the package than one end of the first suction pad 1 in the first direction.

Meanwhile, when the package is to be detached from the suction pad, positive pressure may be applied to positively offset the negative pressure state of the suction space surrounded by the inner surface of the suction pad and the surface to be sucked of the package so that the package is detached.

A suction-holding operation in a case in which the area of the surface to be sucked of the package is smaller than the suction area S2 of the holding device according to the present embodiment will be described with reference to FIG. 4B.

In a case in which the area of the surface to be sucked of the package is smaller than the suction area S2 of the second suction pad 2 (here, referred to as a small package), a gap, which allows the inside and the outside of the second suction pad 2 to communicate with each other, is formed when the suction pad 2 is in contact with the surface to be sucked of the package. Since the amount of air flowing into the suction pad from the outside of the suction pad through the gap is increased even in a case in which the fluid control device 8 is operated to discharge air from the second suction pad 2 and to generate negative pressure, low negative pressure is generated and a suction force of the second suction pad 2 applied to the small package is reduced. Accordingly, since it is effective to reduce the suction area of the suction pad, it is preferable that the second suction pad 2 is switched to the first suction pad 1.

In order to switch the second suction pad 2 to the first suction pad 1, the fluid control device 8 makes the elastic sheet 5 expand toward the package by supplying air to the closed space portion 7 through the flow passages 4 and 4 and pressurizing the closed space portion 7. When the closed space portion 7 is pressurized and the elastic sheet 5 is made to expand, the first suction pad 1 supported by the elastic sheet 5 is pushed so that one end of the first suction pad 1 is positioned closer to the package than one end of the second suction pad 2 in the first direction. That is, the closed space portion 7 of FIG. 4B more expands as much as the closed space portion 7 of FIG. 4B is more pressurized than the closed space portion 7 of FIG. 4A. Accordingly, the first suction pad 1 is selectively switched from the second suction pad 2.

Since the diameter of the first suction pad 1 is smaller than the diameter of the second suction pad 2, the first suction pad 1 can also suck a package of which the area to be sucked is small.

According to the first embodiment, the device may reduce the size and weight of the device due to the complicated structure of the device and prevents that much time is taken in a holding operation since the suction area cannot be actively selected in advance before suction. Further, according to the holding device of the present embodiment, the suction area of the suction pad can be selectively switched according to the suction state of the package in the suction-holding operation for the package. Accordingly, since a possibility that the suction pad cannot contribute to the generation of a suction-holding force is reduced, the holding device has only to include a required minimum number of suction pads. As a result, facility cost can be reduced, a space can be saved, and work efficiency is improved. If the size of the surface to be sucked of the package can be detected in advance by an image recognition device or the like, the suction unit may be controlled so that the package is not sucked by the second suction pad 2 first and is sucked by the first suction pad 1 first as illustrated in the flow chart of FIG. 3.

Meanwhile, the first and second suction pads 1 and 2, which are inner and outer double suction pads, have been used in the first embodiment, but inner and outer double suction pads do not necessarily need to be used and multiple suction pads may be used. Further, the shape of the suction portion of each of the first and second suction pads 1 and 2 does not necessarily need to be an annular shape and may be a triangular shape or a rectangular shape. Furthermore, the cross-sectional shape of the first or second suction pad 1 or 2 taken in the first direction may be a circular shape or a polygonal shape (a triangular shape, a pentagonal shape, and the like) and may be the shape of a bellows. Moreover, the shape of the elastic sheet 5 may be a shape of which the diameter with respect to the central axis of a column parallel to the first direction varies, and may be, for example, a conical shape, a hemispherical shape, or the like.

The flow passages 4 and 4, which discharge or supply air from or to the closed space portion 7, have been illustrated at two positions in FIG. 1, but may be provided on at least one position.

Further, the inside of the closed space portion 7, which can expand and contract, of the suction unit 18 may be depressurized through the flow passages 4 and 4 to make the suction operation of the second suction pad 2, which is performed in Step S3 of FIG. 3, more reliable. In this case, the closed space portion 7 contracts. For this reason, the suction surface of the first suction pad 1, which is supported by the elastic sheet 5, is lifted from the suction surface of the second suction pad 2 (is relatively moved in the first direction), so that the suction of the second suction pad 2 can be made more reliable. For example, the operation in which the first suction pad 1 is lifted (is relatively moved in the first direction) is particularly effective in a case in which a convex portion is present on the surface to be sucked of the package inside the second suction pad 2 or a case in which the surface to be sucked of the package inside the second suction pad 2 is curved and bulges toward the suction pad. In regard to “is relatively moved”, both the first and second suction pads 1 and 2 may be moved and only one of the first and second suction pads 1 and 2 may be moved.

### Second Embodiment

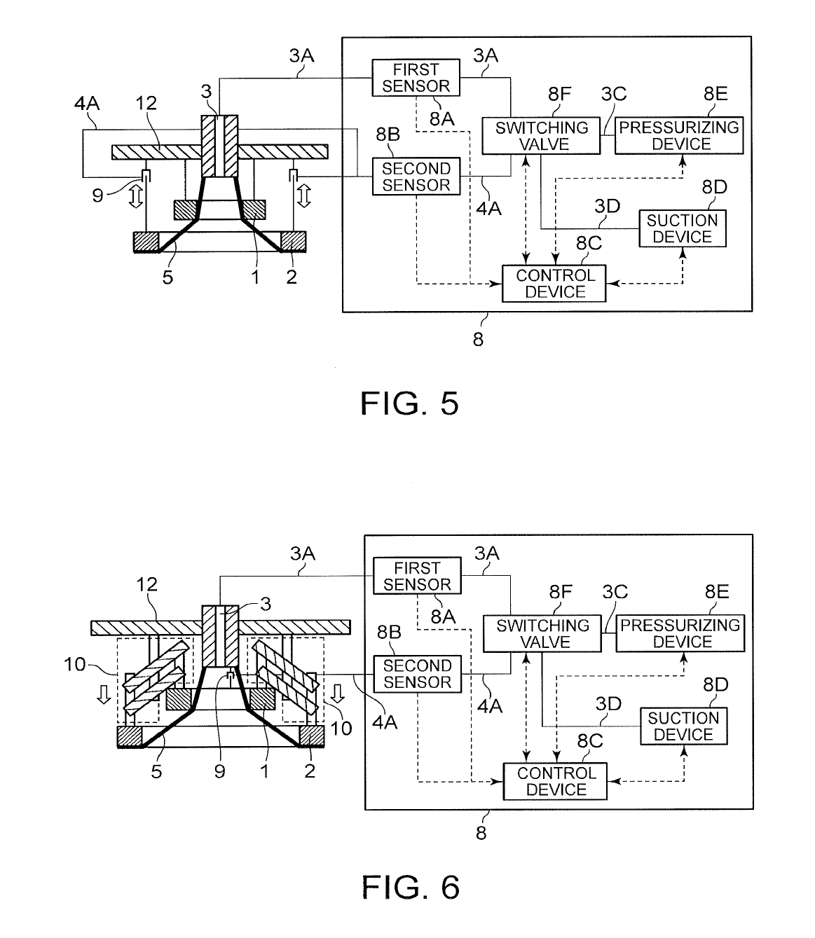

FIG. 5 illustrates a holding device according to the present embodiment. A difference between the first and second embodiments will be mainly described.

The first suction pad 1 has been moved in the first direction in the holding device according to the first embodiment, but the second suction pad 2 can be moved in the first direction in the holding device according to the present embodiment. Further, in the first direction in the holding device according to the first embodiment, the elastic sheet 5 has been provided on the suction pads 1 and 2. However, in the holding device according to the present embodiment, the elastic sheet 5 is provided under the suction pads 1 and 2, is connected to the edge of the flow passage 3 not to hinder the discharge or supply of fluid, and is connected to one end of the second suction pad 2 through the hole of the first suction pad 1. That is, a package, which to be sucked and held, and the elastic sheet 5 come into contact with each other. In addition, in the first embodiment, one, which is used to suck and hold the package, of the first and second pads 1 and 2 has been selectively determined by the adjustment of the flow of air into or out of the closed space portion 7. On the other hand, in the holding device according to the present embodiment, a substrate 12 is provided above the suction pads 1 and 2 in the first direction. Two movable parts 9, which move the second suction pad 2 in the first direction, are mounted on the substrate 12, and one, which is used to suck and hold the package, of the first and second pads 1 and 2 is selectively determined by the movement of the second suction pad 2 in the first direction.

The movable part 9 is a part that is moved in the first direction through pressurization or depressurization by the fluid control device 8. For example, an air cylinder is used as the movable part 9.

The number of the movable parts 9 is not limited to the embodiment of FIG. 5 and at least one movable part 9 may be provided.

Since the closed space portion 7 can be omitted in the holding device according to the present embodiment, there is no concern that the closed space portion 7 may be pressurized over an allowable pressure value and burst due to the excess supply of air. Accordingly, robustness and operation reliability can be improved in addition to the effects of the holding device according to the first embodiment.

### Third Embodiment

A difference between the second and third embodiments will be described.

FIG. 6 illustrates a holding device according to the present embodiment.

The holding device according to the present embodiment includes one movable part 9 that is mounted on the first suction pad 1 and mechanisms (hereinafter, referred to as four-node link mechanisms) each of which include four links for being capable of moving the second suction pad 2 in the first direction.

Further, considering the trajectory of a link unit 10, a joint between the link unit 10 and the second suction pad 2 has an arc-shaped trajectory in the embodiment of FIG. 6. Accordingly, it is preferable that the joint slides on a plane substantially orthogonal to the first direction. For example, a structure in which a pin and a slot are combined with each other may be employed. It is preferable that at least three or more four-node link mechanisms are provided to stably maintain the position/posture of the second suction pad 2 at the time of suction. For example, when two four-node link mechanisms are provided, there is a possibility that the second suction pad 2 may be rotated about an axis passing through the joint of each four-node link mechanism. Further, the elastic sheet 5 has been provided on the suction pads in the first direction in the holding device according to the first embodiment, but the elastic sheet 5 is provided under the suction pads as in the holding device according to the second embodiment in the holding device according to the present embodiment.

In addition, two movable parts 9 do not need to be provided and at least one movable part may be provided. Further, a joint between the link units 10 may slide separately from the mechanism in which the joint between the link unit 10 and the second suction pad 2 slides. In addition, the material of the link unit 10 is not limited to a rigid body and may be an elastic body, and the joint may be elastically deformed instead of sliding.

A structure, which moves the second suction pad 2, is not limited thereto, and may be a structure in which, for example, a linear cylinder is directly disposed. However, since the suction pad uses a pneumatic drive source, it is preferable that the linear cylinder uses not electric, drive but pneumatic drive in terms of space saving achieved from the unification of a drive source.

Since the four-node link mechanisms are moved in the first direction while interlocking with each other, the number of switching valves 8F of the holding device according to the present embodiment can be made smaller than that of the holding device according to the third embodiment using flat tubes. Further, since the parallelism between the first and second suction pads 1 and 2 is easily kept in an operation for moving the second suction pad 2 up and down by the four-node link mechanisms, a robust structure is obtained. Furthermore, when the four-node link mechanism is changed to a serial link mechanism through a reduction in the number of links, the number of parts can be reduced and a closed link structure is formed by the second suction pad 2, the serial link mechanism, and the substrate 12 in the structure of the serial link mechanism. Accordingly, inclination correspondence can be given to the second suction pad 2 by the effect of the closed link structure.

### Fourth Embodiment

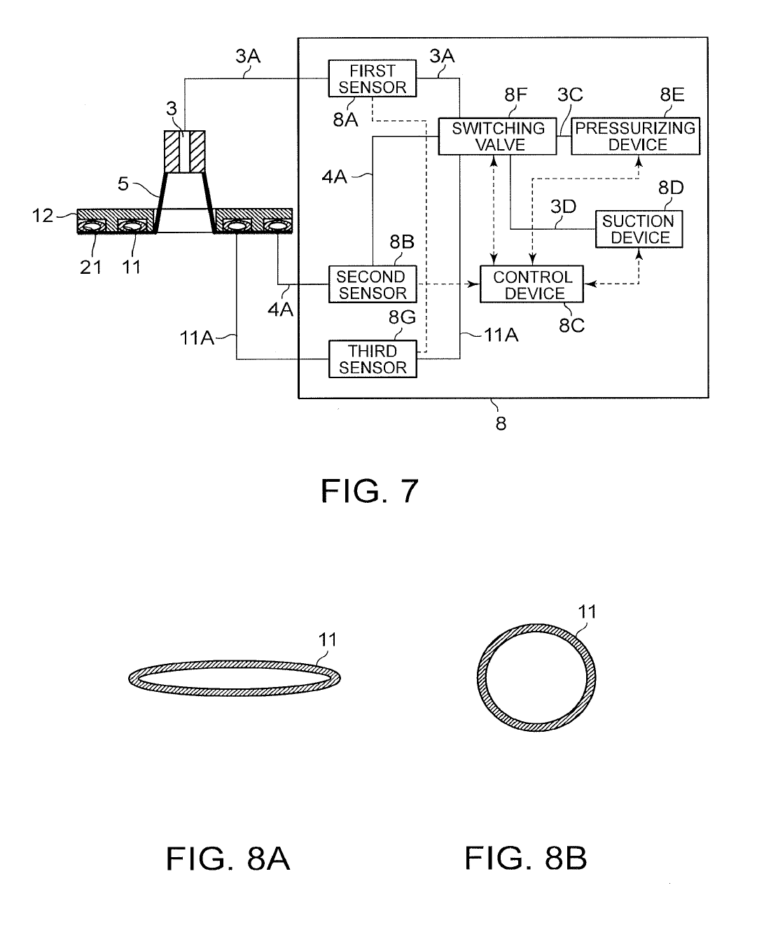

FIG. 7 illustrates a holding device according to the present embodiment.

The holding device according to the present embodiment includes a substrate 12, a flow passage 3 that supplies or discharges air to or from the substrate 12, inner and outer double flat tubes 11 and 21 that are provided in the substrate 12 in a first direction, an elastic sheet 5 which covers the lower surface of the flat tubes and the lower surface of the substrate 12 in the first direction and of which the shape is changed by the expansion or contraction of the flat tubes, and a fluid control device 8.

Further, in the holding device according to the first embodiment, the elastic sheet 5 has been provided on the suction pads in the first direction. However, in the holding device according to the present embodiment, the elastic sheet 5 is provided under suction pads 1 and 2 (in the present embodiment, the inner flat tube 11 of the flat tubes 11 and 21 dually provided at inner and outer portions corresponds to a first suction pad 1 and the outer flat tube 21 corresponds to a second suction pad 2). Meanwhile, the shape of the flat tube 11 is assumed as an annular shape in FIG. 7 but may be a polygonal shape, such as a rectangular shape.

The holding device according to the present embodiment is different from holding device according to the second embodiment in that the number of flow passages to the holding device from a switching valve 8F is increased. In FIG. 7, one flow passage is added and flow passages of three systems are provided in total. A tube 11A connects the inner flat tube 11 to the switching valve 8F and includes a third pressure sensor 8G that is provided on the middle of the path thereof.

As in the first embodiment, the switching valve 8F is connected to a pressurizing device 8E and a suction device 8D by tubes 3C and 3D, respectively. A tube 4A connects the outer flat tube 21 to the switching valve 8F, and includes a second pressure sensor 8B that is provided on the middle of the path thereof.

FIG. 8A illustrates the cross-section of the flat tube 11 having contracted and FIG. 8B illustrates the cross-section of the flat tube 11 having expanded. The flat tube 11 is a tube that is obtained by forming the cross-sectional shape of, for example, a heated thermoplastic tube having a diameter of 12 mm in a flat shape through pressure contact and cooling the thermoplastic tube in this state. For example, urethane, nylon, a fluororesin, polyolefin, polyurethane elastomer, and the like are used as the material of the thermoplastic tube.

When fluid is not supplied to the flat tube 11, the cross-section of the flat tube 11 is in a flat state. When fluid is supplied to the flat tube 11, a force is generated in the lateral direction of the cross-section of the flat tube 11 and the flat tube 11 expands. In the embodiment of FIG. 7, the lateral direction corresponds to the first direction.

Further, the flat tubes are disposed in an annular shape and each of the flat tubes is pressurized or depressurized by the fluid control device 8 so that the suction diameter of the holding device is changed. In the embodiment of FIG. 7, the flat tubes 11 and 21 are dually provided at inner and outer portions on the surface substantially orthogonal to the first direction.

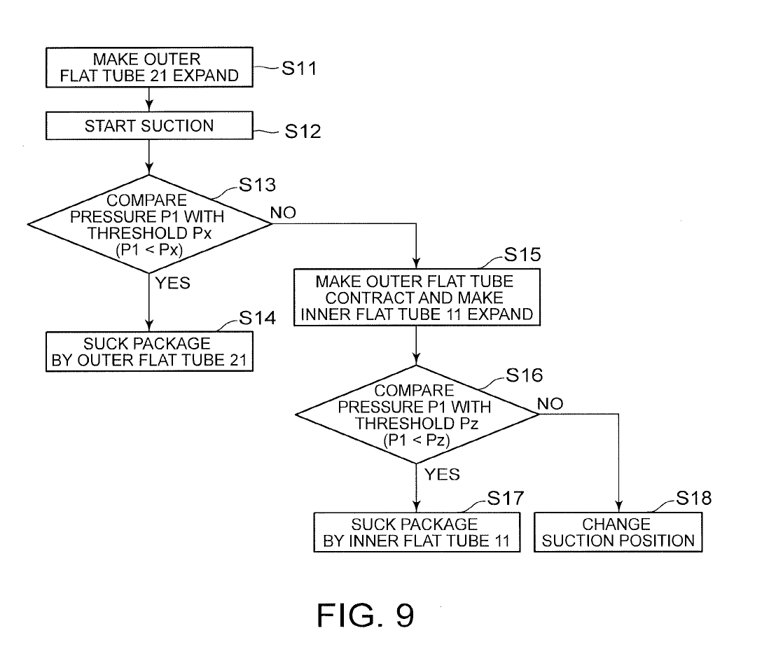

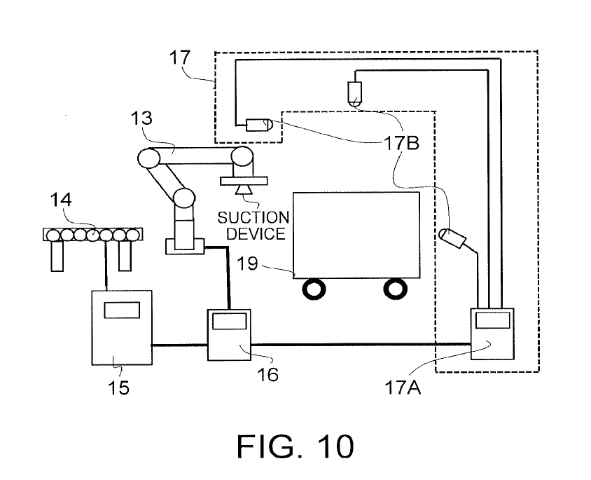

FIG. 9 is a flow chart illustrating the operation of the holding device according to the present embodiment.

The operation will be described while assuming a case in which the holding device is disposed at the tip portion of a manipulator (not illustrated). Specifically, an operation for selectively switching a suction area to a large opening portion and a small opening portion by controlling the expansion and contraction of the outer and inner flat tubes 21 and 11 of the holding device will be described.

First, the control device 8C instructs the switching valve 8F′ to perform a switching operation so that the pressurizing device 8E is connected to the tube 4A, and supplies air to the outer flat tube 21. Accordingly, the outer flat tube 21 expands. At this time, the control device 8C measures pressure P2 in the outer flat tube 21 by the pressure sensor 8B and collects the measured values of the pressure sensor 8B. The control device 8C compares the pressure P2 with a threshold Pb. The threshold Pb is a value as a criterion that is used to determine whether or not the suction surface formed of the outer flat tube 21 sufficiently protrudes as the outer flat tube 21 expands. If P2 is larger than Pb, the control device 8C determines that a protrusion distance is sufficient and processing proceeds to the next step (Step S11).

Next, the suction unit 18 is moved to the surface to be sucked of a package by the manipulator (not illustrated), and is pressed against the surface to be sucked of the package. From this state, the control device 8C instructs the switching valve 8F to perform a switching operation so that the suction device 8D is connected to the tube 3A, and makes the suction device 8D start discharging air of the contact internal space (Step S12).

When the suction device 8D starts discharging air through the flow passage 3, negative pressure is generated in a space that is surrounded by the suction surface formed of the outer flat tube 21 and the elastic sheet 5 and the surface to be sucked of the package. Accordingly, the package is in close contact with the suction surface. At this time, the control device 8C measures pressure P1 in the flow passage 3 or 3A by the pressure sensor 8A and collects the measured values of the pressure sensor 8A. In Step S13, the control device 8C compares the pressure P1 with a threshold Px (Step S13). The threshold Px is a value as a criterion that is used to determine whether or not negative pressure sufficient for the suction surface formed of the outer flat tube 21 to hold the package is generated.

If P1 is smaller than Px, the control device 8C determines that a sufficient suction force is generated and the package is sucked and held by the suction surface formed of the outer flat tube 21 as it is (Yes in Step S13, Step S14).

On the other hand, since air flows into the suction space in a case in which, for example, a gap is formed between the outer flat tube 21 and the surface to be sucked, sufficient negative pressure cannot be obtained. If P1 is not smaller than Px, the control device 8C determines that a sufficient suction force is not generated. A situation in which a small gap is formed between the outer flat tube 21 and the surface to be sucked of the package since, for example, corners or uneven portions of the package are sucked is thought. When an operation for sucking the package is performed in this state, there is a possibility that the package cannot be held. For this reason, the package is held by the inner flat tube 11 (No in Step S13).

The control device 8C instructs the switching valve 8F to perform a switching operation so that the suction device 8D is connected to the tube 4A, and discharges air from the outer flat tube 21. Accordingly, the outer flat tube 21 contracts. At the same time, the control device 8C instructs the switching valve 8F to perform a switching operation so that the pressurizing device 8E is connected to the tube 11A, and supplies air to the inner flat tube 11. Accordingly, the inner flat tube 11 expands. Therefore, since the suction surface formed of the outer flat tube 21 and the elastic sheet 5 sinks and the suction surface formed of the inner flat tube 11 and the elastic sheet 5 protrudes, a small suction area is formed. Meanwhile, at this time, the control device 8C measures pressure P2 in the outer flat tube 21 by the pressure sensor 8B and collects the measured values of the pressure sensor 8B. The control device 8C compares the pressure P2 with a threshold Pb. The threshold Pb is a value as a criterion that is used to determine whether or not the suction surface formed of the outer flat tube 21 sufficiently sinks as the outer flat tube 21 contracts. If P2 is smaller than Pb, the control device 8C determines that a sinking distance is sufficient. Further, the control device 8C measures pressure P3 in the inner flat tube 11 by the pressure sensor 8G and collects the measured values of the pressure sensor 8G. The control device 8C compares the pressure P3 with a threshold Pg. The threshold Pg is a value as a criterion that is used to determine whether or not the suction surface formed of the inner flat tube 11 sufficiently protrudes as the inner flat tube 11 expands. If P3 is larger than Pg, the control device 8C determines that a sinking distance is sufficient and processing proceeds to the next step (Step S15).

Next, the control device 8C instructs the switching valve 8F to perform a switching operation so that the suction device 8D is connected to the tube 3A. Next, the control device 8C determines whether or not the package can be sucked by the suction surface formed of the inner flat tube 11 and the elastic sheet 5. The control device 8C measures pressure P1 in the flow passage 3 by the pressure sensor 8A and collects the measured values of the pressure sensor 8A. The control device 8C compares the pressure P1 with a threshold Pz (Step S16). The threshold Pz is a value as a criterion that is used to determine whether or not negative pressure sufficient for the suction surface formed of the inner flat tube 11 and the elastic sheet 5 to suck and hold the package is generated. If P1 is smaller than Pz, the control device 8C determines that a sufficient suction force is generated and the package is sucked and held by the suction surface formed of the inner flat tube 11 and the elastic sheet 5 as it is (Yes in Step S16, Step S17). On the other hand, since air flows into the suction space in a case in which, for example, a gap is formed between the suction surface formed of the inner flat tube 11 and the elastic sheet 5 and the surface to be sucked, sufficient negative pressure cannot be obtained. The control device 8C stops the suction operation, and instructs the manipulator (not illustrated) to change the current suction position of the suction unit 18 (No in Step S16, Step S18). Accordingly, the suction position is changed and a suction operation is performed again.

The flat tubes 11 may be multiply disposed unlike in the embodiment of FIG. 7.

In addition to the effect of the holding device according to the second embodiment, the holding device according to the present embodiment can be adapted to be small and lightweight and can realize a suction surface of which the suction area can be easily selected in multiple stages.

### Fifth Embodiment

FIG. 10 is a diagram illustrating an example of an unloading apparatus.

The unloading apparatus according to the present embodiment includes a manipulator 13 that includes the holding device according to any one of the first to fourth embodiments to transfer a required number of packages to an automatic conveyor 14 from a basket cart 19, a conveyance control device 15 that controls the automatic conveyor 14, a robot control device 16, and a three-dimensional position recognition device 17.

The automatic conveyor 14 is connected to the conveyance control device 15 so as to be capable of communicating with the conveyance control device 15, the conveyance control device 15 is connected to the robot control device 16 so as to be capable of communicating with the robot control device 16, and the robot control device 16 is connected to the manipulator 13 and the three-dimensional position recognition device 17 so as to be capable of communicating with the manipulator 13 and the three-dimensional position recognition device 17. Meanwhile, FIG. 10 is a diagram in a case in which communication is performed through a wire, but communication may be performed wirelessly.

Meanwhile, the manipulator 13 is a robot that includes a plurality of joints and can move the holding device by rotating or linearly moving these joints.

One or more range image sensors 17B, 17B, and 17B, which detect the position/posture of a package, are provided as the three-dimensional position recognition device 17. Further, a computer 17A estimates the position/posture of the package by using a plurality of range images that are obtained from the plurality of sensors 17B.

The manipulator 13 in the case of this embodiment is a vertical multi-joint robot.

Since the unloading apparatus according to the present embodiment includes the computer 17A that calculates the number and position/posture information of packages on the basis of measured values of the range image sensors 17B by using the range image sensors 17B, the unloading apparatus according to the present embodiment can measure the three-dimensional position of the uppermost package, which can be sucked and held, among the packages loaded on the basket cart 19.

The flow of the entire processing in a case in which a package is sucked and held by the holding devices according to the first to fourth embodiments will be described. First, when the conveyance control device 15 gets prepared to receive a package of the automatic conveyor 14, the conveyance control device 15 sends a signal for requesting the measurement of a three-dimensional position to the computer 17A of the three-dimensional position recognition device 17. When the computer 17A receives the signal for requesting the measurement of a three-dimensional position, the computer 17A starts measuring the three-dimensional position. That is, the computer 17A measures the position/posture information of a plurality of packages by using a plurality of range images that are obtained from the plurality of sensors 17B. Further, a procedure for taking out a package, which can be transferred by the manipulator 13, is determined from the position/posture information of the plurality of packages. At this time, an error detection signal is sent to the conveyance control device 15 if an inverted package is detected. If an error is not detected, three-dimensional position information is sent to the robot control device 16. When the robot control device 16 receives the three-dimensional position information, the robot control device 16 transfers packages onto the automatic conveyor from the basket cart 19 by operating the holding device of the manipulator 13. When the robot control device 16 completes the transfer of all the packages, the robot control device 16 sends a transfer completion signal to the three-dimensional position recognition device 17. The three-dimensional position recognition device 17 remeasures a three-dimensional position to determine whether or not a package remains on the basket cart 19. If a package remains, three-dimensional position information is sent to the robot control device 16 and the transfer of the package is performed. If a package does not remain, a transfer completion signal for the basket cart 19 is sent to the conveyance control device 15. When the conveyance control device 15 receives the transfer completion signal for the basket cart 19, the conveyance control device 15 gives a notification to a worker or the like and the worker or the like moves the basket cart 19 from which all packages have been transferred and are not present and supplies the next basket cart 19. Actually, the uppermost package, which is to be easily sucked and held by the holding device of the manipulator 13, needs to be recognized. Accordingly, a package taking-out order can be examined from the position/posture information of a package that is obtained by three-dimensional measuring means. The robot control device 16 takes out the packages from the basket cart 19 at least one by one by operating the manipulator 13 on the basis of the sent three-dimensional position information, and transfers the packages onto the automatic conveyor 14. The transferred packages are conveyed by the automatic conveyor 14, and the packages sorted by, for example, destination are loaded on the basket cart 19 in the loading work.

The basket cart 19 is not limited to the embodiment of FIG. 10 and may be a pallet. Each of the holding devices according to the first to fourth embodiments is not installed on only the manipulator 13, and may be mounted on the basket cart 19 or the like. Further, an operation for making air flowing into and out of the holding devices according to the first to fourth embodiments may be performed manually.

Instructions described in the processing procedures described in the above-mentioned embodiments can be performed on the basis of on programs as software. A general-purpose computer system stores the programs in advance and also can obtain the same effects as the effects of the above-mentioned holding devices by reading in the programs. The instructions described in the above-mentioned embodiments are stored as computer-executable programs in a magnetic disk (a flexible disk, a hard disk, or the like), an optical disk (CD-ROM, CD-R, CD-RW, DVD-ROM, DVD±R, DVD±RW, Blu-ray (registered trademark) Disc, or the like), a semiconductor memory, or a recording medium similar thereto. If a recording medium can be read by a computer or a built-in system, any storage format can be used as the storage format of the recording medium. The same operations as the operations of the holding devices according to the above-mentioned embodiments can be performed when a computer reads in programs from the recording medium and executes instructions described in the programs on the basis of the program by a CPU. The computer may acquire or read in the programs via a network. Furthermore, an operating system (OS) running on the computer on the basis of the instructions of programs installed in the computer or the built-in system from the recording medium, database management software, and middleware (MW), such as a network, may perform a part of processing that embodies the present embodiment. Moreover, the recording medium of the present embodiment is not limited to a medium independent of the computer or the built-in system, and also includes a recording medium that stores or temporarily stores programs downloaded through a LAN, the Internet, and the like. Further, the number of recording mediums is not limited to one. In a case in which processing of the present embodiment is performed from a plurality of mediums, the plurality of mediums are included in the recording medium of the present embodiment. The mediums may have any configuration.

Meanwhile, the computer or the built-in system of the present embodiment is to perform each processing of the present embodiment on the basis of the programs stored in the recording medium; and may have any configuration corresponding to a single device, such as a personal computer and a microcomputer, a system to which a plurality of devices are connected through the network, and the like. Further, the computer of the present embodiment is not limited to a personal computer hut includes, for example, a microcomputer and an arithmetic processing unit included in information processing equipment. The computer is a general term of equipment or a device capable of performing functions of the present embodiment by the programs.

Furthermore, in the present embodiment, each of the mechanism that relatively moves the suction pads 1 and 2 by discharging or supplying air from or to the closed space portion 7, the mechanism that relatively moves the suction pads 1 and 2 by the movable parts 9, the link mechanism, and the mechanism that relatively moves the suction pads 1 and 2 by discharging or supplying air from or to the flat tubes 11 and 21 is also referred to as a moving mechanism.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A holding device comprising:
a first suction pad capable of sucking an object;
a second suction pad capable of sucking the object, said second suction pad surrounding the first suction pad on a plane; and
a moving mechanism relatively moving the first suction pad toward the second suction pad in a first direction from the first suction pad toward the object.

2. The holding device of claim 1,
wherein the second suction pad is positioned closer to the object than the first suction pad by the moving mechanism.

3. The holding device of claim 1,
wherein the first suction pad is positioned closer to the object than the second suction pad by the moving mechanism.

4. The holding device of claim 1, further comprising:
a selection unit selecting the first suction pad or the second suction pad based on a suction state.

5. The holding device of claim 1,
wherein the first suction pad and the second suction pad are a substantially cylindrical shape or polygonal shape.

6. The holding device of claim 1,
wherein the cross-sectional shape of the first suction pad or the second suction pad, taken in the first direction, is a circular shape, a pentagonal shape, or a bellows shape.

7. The holding device of claim 1,
wherein the first suction pad and the second suction pad are composed of a flat tube.

8. The holding device of claim 1,
wherein the moving mechanism is composed of a link mechanism.

9. The holding device of claim 1,
wherein the moving mechanism moves the first suction pad and the second suction pad by discharging or supplying air.

10. The holding device of claim 1,
wherein the moving mechanism moves the first suction pad and the second suction pad by a movable part.

11. The holding device of claim 1, further comprising:
a control unit controlling for changing a driving state when the first or second suction pad is switched.

12. The holding device of claim 1, further comprising:
a multiple suction pad located at outside of the second suction pad on the plane.

13. The holding device of claim 1, further comprising:
an elastic sheet closing a space portion, wherein an shape of the elastic sheet is deformed by pressure.

14. The holding device of claim 13,
wherein the elastic sheet is located at an object side or an opposite object side in the first direction.

15. A holding method comprising:
sucking an object with an outer suction pad;
holding the object when the pressure of the outer suction pad is over a predetermined first pressure;
moving relatively the outer suction pad toward an object when the pressure of the outer suction pad is under the predetermined first pressure;
sucking an object with an inner suction pad and,
holding the object with the inner suction pad.

16. An unloading apparatus comprising:
a holding device including a first suction pad capable of sucking a suction surface of an object, a second suction pad capable of sucking the suction surface of the object, the second suction pad surrounding the first suction pad on a plane and a moving mechanism relatively moving the first suction pad and the second suction pad in a first direction from the first suction pad toward the object; and
a manipulator having the holding device; and
a robot control device controlling the manipulator.

17. A holding device comprising:
a first suction pad sucking a suction surface of an object;
a second suction pad sucking the suction surface of the object, the second suction pad surrounding the first suction pad on a plane substantially orthogonal to a first direction from the first suction pad toward the object;
an elastic sheet covering a side of the first suction pad and a side of the second suction pad;
a case forming an predetermined space between the elastic sheet; and
a moving mechanism relatively moving the first suction pad and the second suction pad in the first direction by discharging or supplying air into the space.
